(19) United States
(12) Patent Application Publication
(10) Pub. No.: US 2026/0177037 A1
(43) Pub. Date: Jun. 25, 2026

(54) A METHOD OF REPAIRING A SPAR CAP AND ROTOR BLADE HAVING A REPAIRED SPAR CAP

(71) Applicant: LM Wind Power A/S, Kolding (DK)

(72) Inventors: Sohil Batra, Hampshire (GB); Raghavender Goud Deshagoni, Hampshire (GB); Simon Brault, Gaspé (CA)

(21) Appl. No.: 19/125,476

(22) PCT Filed: Oct. 25, 2023
(86) PCT No.: PCT/EP2023/079839

§ 371 Date: Apr. 29, 2025

(30) Foreign Application Priority Data
Oct. 31, 2022 (EP) 22204720.1

(51) Int. Cl. F03D 80/50; F03D 1/06

(52) U.S. Cl. CPC F03D 80/502; F03D 1/0681; F05B 2280/6003

(57) ABSTRACT

A method (1000, 1001) of repairing a spar cap (51, 52, 53) of a wind turbine blade (10, 108) includes removing (1100, 1101) a damaged portion (531d) of a fiber-reinforced plastic part (530, 531-33) of the spar cap (51, 52, 53) thereby forming a recess (531r) adjacent to a non-damaged portion (531n) of the fiber-reinforced plastic part, the non-damaged portion (531n) comprising electrically conductive fibers at least substantially orientated in a first direction (F). A bottom wall and a sidewall of the recess (531r) is covered (1200, 1210, 1220) a with an insulating material (534). A fiber-reinforced plastic filling (535, 535′) is formed on the insulating material (534). The fiber-reinforced plastic filling (535, 535′) is covered with an electrically conductive material (536) in electrical connection with the non-damaged portion (531n).

### FIELD

The present subject matter relates generally to repairing a spar cap, in particular a spar cap of a wind turbine blade, and to a rotor blade with a repaired spar cap, in particular a respective wind turbine rotor blade.

### BACKGROUND

Wind power is considered one of the cleanest, most environmentally friendly energy sources presently available, and wind turbines have gained increased attention in this regard. A modem wind turbine typically includes a tower, generator, gearbox, nacelle, and a rotor with one or more rotor blades. The rotor blades capture kinetic energy from wind using known foil principles and transmit the kinetic energy through rotational energy to turn a shaft coupling the rotor blades to a gearbox, or if a gearbox is not used, directly to the generator. The generator then converts the mechanical energy to electrical energy that may be deployed to a utility grid.

Wind turbine blades are typically made using materials having a high stiffness to weight ratio such as fiber-reinforced plastic. This applies in particular to spar caps of wind turbine blades which act as primary load carrying members in the blades and are thus subjected to high mechanical loads during operation. Furthermore, the spar cap may provide the primary path of conduction of lightning current from the tip to the root of the blade. When parts of a spar cap made from fiber-reinforced plastic have manufacturing deviations and/or are damaged, e.g. due to aging or fatigue, it is often challenging to repair the damaged spar cap, in particular if both mechanical and lightning protection functionality is to be ensured by the repaired spar cap. This also applies to spar caps made of electrically conductive fiber-reinforced plastic, i.e. a fiber-reinforced plastic having aligned electrically conductive fibers, such as a carbon fiber-reinforced plastic. Note that such a fiber-reinforced plastic is a good electrical conductor in its fiber direction and that a damage and/or the repairing of the damage may result in interrupting the continuity of the conductive fibers and, thus, in a discontinuity for the electrical path along the spar cap. Accordingly, special care is typically required during repair of damaged spar caps to avoid flashovers from the main down-conductor and/or sparks during a lightning strike, in particular a strike across a repair interface.

Accordingly, the present disclosure provides a method of repairing a spar cap according to claim 1, and a rotor blade according to claim 14.

### BRIEF DESCRIPTION

Aspects and advantages of the invention will be set forth in part in the following description, or may be obvious from the description, or may be learned through practice of the invention.

In one aspect, the present disclosure is directed to a method for repairing a spar cap of a wind turbine blade, the spar cap including a fiber-reinforced plastic part, for example a fiber-reinforced plastic part including a stack of fiber reinforced layers. The method includes removing a damaged portion of the fiber-reinforced plastic part. Thereby a recess adjacent to a non-damaged portion of the fiber-reinforced plastic part is formed. The non-damaged portion includes electrically conductive fibers which are at least substantially orientated in a first direction which is in the following also referred to as (main) fiber direction. A bottom wall and a sidewall of the recess is covered a with an insulating material. A fiber-reinforced plastic filling is formed on the insulating material. The fiber-reinforced plastic filling is covered with an electrically conductive material in electrical connection with the non-damaged portion. Typically, the bottom wall and all sidewalls of the recess are covered a with the insulating material.

The non-damaged portion may in particular be a unidirectional fiber-reinforced plastic. As used herein, the term “unidirectional fiber-reinforced plastic” intends to describe that that all or at least 95% of the fibers are at least substantially, i.e. within an accuracy of at most several degrees, typically at most 2° or even 1°, directed in the (main) fiber direction.

As used herein, the term “damaged portion of the fiber-reinforced plastic part” typically embraces portions of the fiber-reinforced plastic part that are defect and/or not fully functional, in particular due to a damage and/or due to not manufacturing the fiber-reinforced plastic part within given manufacturing tolerance(s)/specification(s). Likewise, the non-damaged portion of the fiber-reinforced plastic part is typically an at least substantially functional portion (with respect to mechanical and/or electric properties), more typically a fully functional portion of the fiber-reinforced plastic part, in particular a not damaged portion of the fiber-reinforced plastic part manufactured within the manufacturing tolerance(s)/specification(s).

Due to covering the bottom wall and sidewall(s) of the recess with an insulating material, forming the fiber-reinforced plastic filling on the insulating material, and covering the fiber-reinforced plastic filling with the electrically conductive material in electrical, typically in low Ohmic connection with the non-damaged portion, the damaged spar cap can be repaired in a comparatively fast and/or efficient manner, so that both mechanical stability and electric functionality as lightning conductor is reliably reestablished. For example, less expensive equipment may be required for the repair. However, the repair may also be performed with complex equipment such as vacuum bagging equipment. Further, comparatively soft materials may be used for repairing. Note that the insulating material can safely prevent flash over currents etc. during lightening.

The recess is typically formed at an outer surface of the fiber-reinforced plastic part.

Further, the damaged portion is typically removed mechanically. This may include chamfering the fiber-reinforced plastic part with respect to the first direction, but also chamfering the fiber-reinforced plastic part with respect to a second direction perpendicular to the first direction.

Typically, the fiber-reinforced plastic part is chamfered such that the recess is, in a top view, surrounded by the non-damaged portion.

The method is typically performed such that the insulating material covers the non-damaged portion next to the sidewall(s) of the recess, in particular as a respective electrically insulating layer. Accordingly, flash over currents during lightening events can be particularly safely be prevented.

The insulating material typically includes electrically non-conductive fibers, in particular glass fibers.

Covering the bottom wall and the sidewall(s) of the recess may include at least one of, typically several or even all of.
forming at least on insulating fiber-reinforced layer on the bottom wall and the sidewall of the recess;
layup of electrically non-conductive fibers, in particular hand layup of the electrically non-conductive fibers;
impregnating the electrically non-conductive fibers with a resin, in particular applying a vacuum infusion of the resin; and
curing or hardening the impregnated electrically non-conductive fibers.

Curing or hardening may include polymerization of the resin, self-curing, and/or may be achieved thermally.

Forming the fiber-reinforced plastic filling may include at least one of, typically several or even all of:
substantially filling a remaining recess above the insulating material with typically electrically conductive fibers;
layup of the typically electrically conductive fibers, in particular hand layup of the fibers;
impregnating the fibers with a resin, for example by using vacuum infusion of the resin.

Alternatively or in addition, forming the fiber-reinforced plastic filling may include at least one of, typically both of:
applying an adhesive on the insulating material; and
substantially filling a remaining recess above the insulating material and/or the adhesive with a patch including fibers, typically the electrically conductive fibers, in particular a respective pre-impregnated patch.

Furthermore, forming the fiber-reinforced plastic filling may include curing the impregnated fibers and/or the patch.

Curing the impregnated electrically non-conductive fibers and curing the impregnated typically electrically conductive fibers and/or the patch may be achieved by a common curing process. Accordingly, the repair effort may be reduced.

Prior to covering the fiber-reinforced plastic filling with the electrically conductive material, an edge region of the cured impregnated fibers may be mechanically smoothed. Accordingly, mechanical strength and/or long term stability may be improved.

Covering the fiber-reinforced plastic filling with the electrically conductive material may include at least one of, typically several or even all of:
forming the electrically conductive material at the fiber-reinforced plastic filling and at the non-damaged portion of the fiber-reinforced plastic part;
completely covering at least one of the fiber-reinforced plastic filling and the insulating material, at least in a cross-section parallel to the first direction, typically in any cross-section perpendicular to the bottom wall;
layup of electrically conductive fibers, in particular hand layup of the electrically conductive fibers;
impregnating the electrically conductive fibers with a resin, in particular using vacuum infusion of the resin; and
curing the impregnated electrically conductive fibers, e.g. thermally curing the impregnated electrically conductive fibers.

The electrically conductive fibers may in particular be carbon fibers.

The electrically conductive material may form an electrical bypass (for a current during a lightening event) and/or is typically formed by and/or includes carbon fibers, a carbon mesh, a carbon tow, a metal mesh such as a copper mesh, and/or a fiber-reinforced plastic layer.

In one aspect, the present disclosure is directed to a repaired spar cap. The repaired spar cap includes a fiber-reinforced plastic part including an electrically conductive unidirectional fiber reinforced layer. A fiber-reinforced repair patch is inserted into (a recess of) the electrically conductive unidirectional fiber reinforced layer. An electrically insulating layer covers a bottom and a sidewall of the fiber-reinforced repair patch. An electrical bypass is arranged on the fiber reinforced layer, in electrical connection with the fiber reinforced layer, in particular in low Ohmic connection with the fiber reinforced layer, and covers a top side of the fiber-reinforced repair patch.

The electrical bypass is typically formed by and/or includes at least one of the electrically conductive fibers, a carbon mesh, a carbon tow, a metal mesh, and an (a further) electrically conductive fiber-reinforced plastic layer.

The fiber-reinforced repair patch may be inserted into (a recess of) two or even more than two electrically conductive unidirectional fiber reinforced layers of the repaired spar cap.

The electrically conductive unidirectional fiber reinforced layer(s) and the fiber-reinforced repair patch may include fibers which are at least substantially orientated in a first direction (fiber direction).

Typically the electrically conductive unidirectional fiber reinforced layer includes electrically conductive fibers, in particular carbon fibers.

According to an embodiment, the fiber-reinforced plastic part includes a stack of fiber reinforced layers.

The damaged portion of the fiber-reinforced plastic part may correspond to a portion of one fiber reinforced layer only.

Alternatively, the damaged portion of the fiber-reinforced plastic part may correspond to respective portions of two or even more fiber reinforced layers.

Further, the fiber-reinforced plastic part typically includes an electrically conductive interlayer arranged between two of the fiber reinforced layers.

The electrically conductive interlayer may form a main down-conductor for lightening protection of the spar cap. For example, the electrically conductive interlayer may be implemented and or include a metal layer or metal mesh, for example a respective Cu-wiring.

The electrically insulating layer may include glass fibers.

Further, the repaired spar cap may be a damaged spar cap that is repaired by the method explained herein.

In one aspect, the present disclosure is directed to a rotor blade including a repaired spar cap as explained herein, in particular a respective wind turbine rotor blade.

In particular, the repaired spar cap may include a fiber-reinforced plastic part including an electrically conductive unidirectional fiber reinforced layer. A fiber-reinforced repair patch is inserted into the fiber reinforced layer. An electrically insulating layer covers a bottom and a sidewall of the fiber-reinforced repair patch. An electrical bypass is arranged on the fiber reinforced layer, in electrical connection with the fiber reinforced layer, in particular in low Ohmic connection with the fiber reinforced layer, and covers a top side of the fiber-reinforced repair patch.

These and other features, aspects and advantages of the present invention will be further supported and described with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a wind turbine that may have a rotor blade with a repaired spar cap according to the present disclosure;

FIG. 2A illustrates a schematic side view of an embodiment of a wind turbine rotor blade with a repaired spar cap according to the present disclosure;

FIG. 2B illustrates a flow chart of a method according to an embodiment of the present disclosure;

FIG. 2C illustrates a flow chart of a method according to an embodiment of the present disclosure; and

FIG. 3A to FIG. 3F and FIG. 4A to FIG. 4D illustrates, in respective views, a method of repairing a damaged spar cap and the formed repaired spar cap according to embodiments of the present disclosure.

Single features depicted in the figures are shown relatively with regards to each other and therefore are not necessarily to scale. Similar or same elements in the figures, even if displayed in different embodiments, are represented with the same reference numbers

### DETAILED DESCRIPTION OF THE INVENTION

Reference now will be made in detail to embodiments of the invention, one or more examples of which are illustrated in the drawings. Each example is provided by way of explanation of the invention, which shall not limit the invention. In fact, it will be apparent to those skilled in the art that various modifications and variations can be made in the present invention without departing from the scope or spirit of the invention, for instance, features illustrated or described as part of one embodiment can be used with another embodiment to yield a still further embodiment. Thus, it is intended that the present invention covers such modifications and variations as come within the scope of the appended claims and their equivalents.

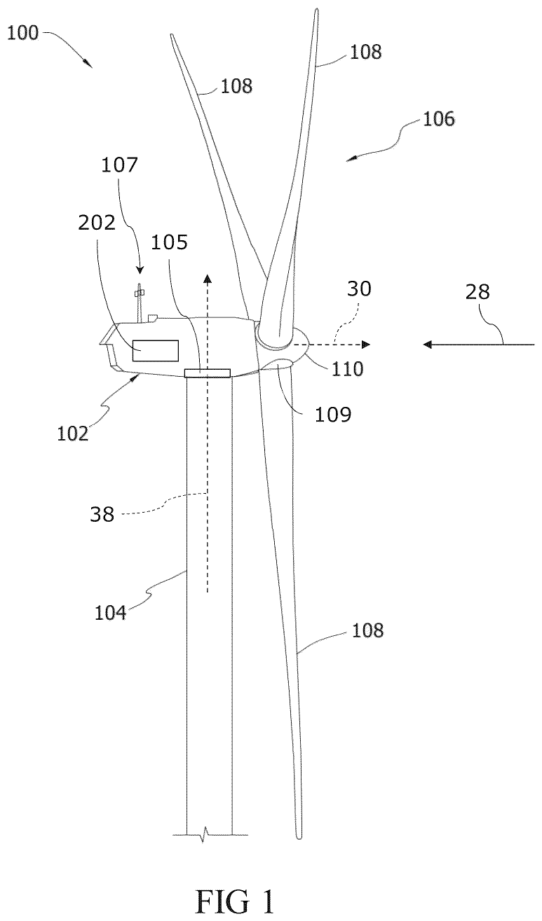

FIG. 1 is a perspective view of a portion of an exemplary wind turbine 100. In the exemplary embodiment, the wind turbine 100 is a horizontal-axis wind turbine. Alternatively, the wind turbine 100 may be a vertical-axis wind turbine. Wind turbine 100 includes a nacelle 102 housing a generator (not shown in FIG. 1). Nacelle 102 is mounted on a tower 104 (a portion of tower 104 being shown in FIG. 1). Tower 104 may have any suitable height that facilitates operation of wind turbine 100 as described herein. Wind turbine 100 also includes a rotor 106 that includes three wind turbine blades 108 attached to a rotating hub 110. In the following, the wind turbine blades are also referred to as wind turbine rotor blades, and rotor blades for short. Alternatively, wind turbine 100 includes any number of blades 108 that facilitates operation of wind turbine 100 as described herein. In the exemplary embodiment, wind turbine 100 includes a gearbox (not shown in FIG. 1) operatively coupled to rotor 106 and a generator (not shown in FIG. 1).

The rotor blades 108 are spaced about the hub 110 to facilitate rotating the rotor 106 to enable kinetic energy to be transferred from the wind into usable mechanical energy, and subsequently, electrical energy.

According to an embodiment, one, two or even all of the exemplary three rotor blades 108 has a repaired spar cap as explained herein.

In one embodiment, the rotor blades 108 have a length ranging from about 15 meters (m) to about 91 m. Alternatively, rotor blades 108 may have any suitable length that enables the wind turbine 100 to function as described herein. For example, other non-limiting examples of blade lengths include 20 m or less, 37 m, 48.7 m, 50.2 m, 52.2 m or a length that is greater than 91 m. As wind strikes the rotor blades 100 from a wind direction 28, the rotor 106 is rotated about an axis of rotation 30. As the rotor blades 108 are rotated and subjected to centrifugal forces, the rotor blades 108 are also subjected to various forces and moments. As such, the rotor blades 108 may deflect and/or rotate from a neutral, or non-deflected, position to a deflected position.

Moreover, a pitch angle of the rotor blades 108, i.e., an angle that determines a perspective of the rotor blades 108 with respect to the wind direction, may be changed by a pitch system 109 to control the load and power generated by the wind turbine 100 by adjusting an angular position of at least one rotor blade 108 relative to wind vectors. During operation of the wind turbine 100, the pitch system 109 may change a pitch angle of the rotor blades 108 such that the rotor blades 108 are moved to a feathered position, such that the perspective of at least one rotor blade 108 relative to wind vectors provides a minimal surface area of the rotor blade 108 to be oriented towards the wind vectors, which facilitates reducing a rotational speed and/or facilitates a stall of the rotor 106.

A blade pitch of each rotor blade 108 may be controlled individually by a wind turbine controller 202 or by a pitch control system. Alternatively, the blade pitch for all rotor blades 108 may be controlled simultaneously by said control systems.

Further, in the exemplary embodiment, as the wind direction 28 changes, a yaw direction of the nacelle 102 may be rotated, by a yaw system 105, about a yaw axis 38 to position the rotor 106 with respect to wind direction 28.

The yaw system 105 may include a yaw drive mechanism provided by nacelle 102.

Further, yaw system 105 may also be controlled by wind turbine controller 202.

For positioning nacelle 102 appropriately with respect to the wind direction 28 as well as detecting a wind speed, the nacelle 102 may also include at least one meteorological mast 107 that may include a wind vane and anemometer. The mast 107 may provide information to the wind turbine controller 202 regarding ambient conditions. This may include wind direction and/or wind speed as well as ambient temperature, ambient moisture, precipitation type and/or amount (if any).

In the exemplary embodiment, the wind turbine controller 202 is shown as being centralized within the nacelle 102, however, the wind turbine controller may also be a distributed system throughout the wind turbine 100, on a support system (not shown in FIG. 1), within a wind farm, and/or at a remote-control center. The wind turbine controller 202 includes a processor and may be configured to perform the methods and/or steps described herein.

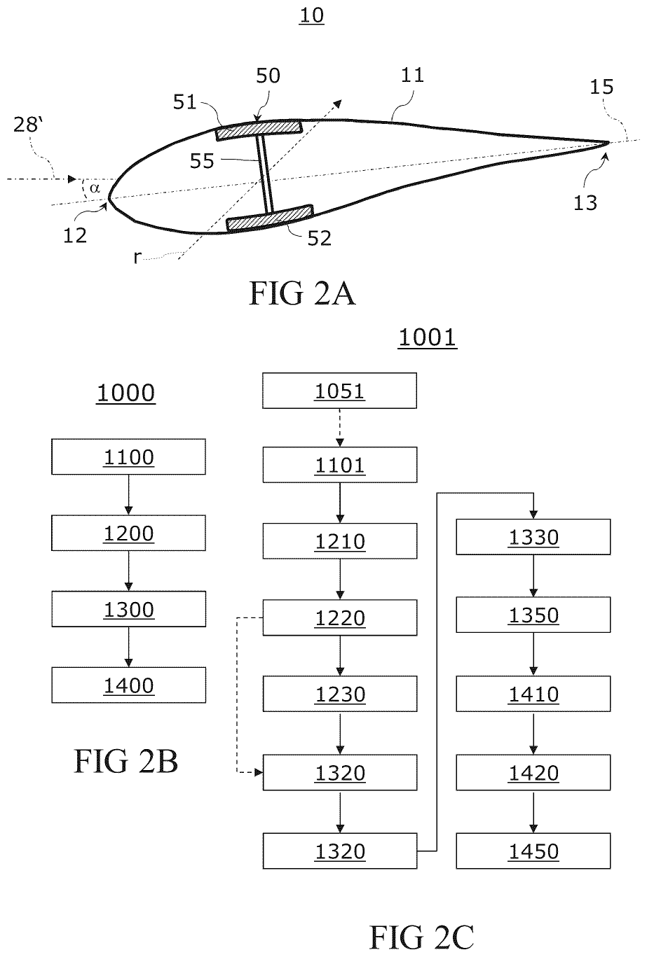

Referring now to FIG. 2A, embodiments of a wind turbine (rotor) blade 10 are explained. Wind turbine blade 10 may be used as rotor blade 108 of wind turbine 100 explained above with respect to FIG. 1.

The exemplary wind turbine rotor blade 10 has an outer shell 11 defining an airfoil.

Wind turbine blade 10 extends in a longitudinal direction r from a root portion to a tip portion. The root and tip portions are connected with each other via a middle portion of shell 11 that may be shaped as shown in FIG. 2A.

“Angle of attack” is a term that is used in to describe the angle α between the chord line 15 of the blade 10 and the vector 28′ representing the relative motion between the blade and the air. “Pitching” refers to rotating the angle of attack of the entire blade 10 along the spanwise axis and longitudinal direction r, respectively, into or out of the wind in order to control the rotational speed and/or absorption of power from the wind. For example, pitching the blade “towards feather” rotates of the leading edge of the blade 10 into the wind, while pitching the blades “towards stall” rotates the leading edge of the blade out of the wind.

The main load bearing structure of wind turbine rotor blade 10 is implemented as a spar 50 attached to shell 11.

Note that rotor blade 10 is typically fabricated by securing various “shell” and/or “rib” portions to one or more “spar” members extending spanwise (in longitudinal direction r) along the inside of the blade for carrying most of the weight and aerodynamic forces on the blade. Spars 50 are typically configured as I-shaped beams having a web 55, referred to as a “shear web,” extending between two flanges, referred to as “caps” or “spar caps” 51, 51, that are secured to the inside of the suction and pressure surfaces of the blade. However, other spar configurations may also be used including, but not limited to “C-,” “D-,” “L-,” “T-,” “X-,” “K-,” and/or box-shaped beams.

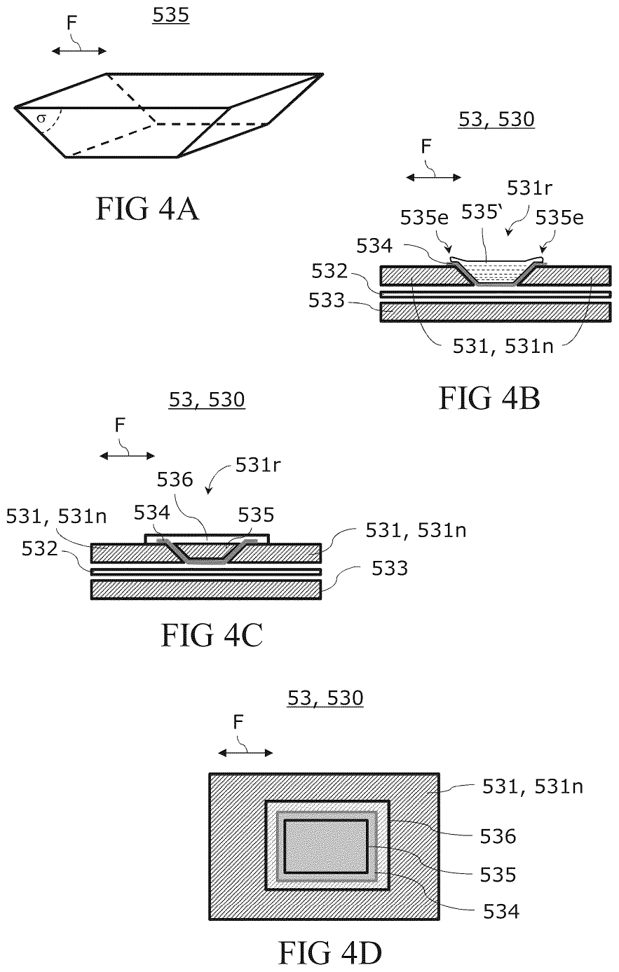

According to an embodiment, one or both of the spar caps 51, 52 is a repaired spar cap as explained in detail in the following and shown in FIG. 4C and FIG. 4D.

In particular, at least one of the spar caps 51, 52 of rotor blade 10 may have a repaired fiber-reinforced plastic part 530 as shown for spar cap 53 in FIG. 4C and FIG. 4D.

In the exemplary embodiment, fiber-reinforced plastic part 530 includes an electrically conductive unidirectional fiber reinforced layer 531, and a fiber-reinforced repair patch 535 inserted into a recess 531r (formed during the repair) of the fiber reinforced layer 531. An electrically insulating layer 534 covers the bottom and sidewalls of the fiber-reinforced repair patch 536. An electrical bypass 536 is arranged at and on the fiber reinforced layer 531, in electrical connection with the fiber reinforced layer 531, and covers a top side (opposite the bottom) of the fiber-reinforced repair patch 536.

Typically, a non-damaged portion 531n of fiber-reinforced plastic part 530 is a unidirectional fiber-reinforced plastic part with electrically conductive fibers at least substantially orientated in a first or main direction F which may at least substantially correspond to the longitudinal direction r of the rotor blade.

The non-damaged portion 531n may in particular be a unidirectional carbon fiber-reinforced plastic part.

FIG. 2B illustrates a flow chart of a method 1000 for repairing a spar cap of a wind turbine rotor blade.

In a first block 1100, a damaged portion of a fiber-reinforced plastic part is completely removed. Accordingly, a recess adjoining the non-damaged portion of the fiber-reinforced plastic part is formed.

In a subsequent block 1200, the bottom and sidewalls of the recess are covered with an insulating (dielectric) material, typically forming an insulating (dielectric) layer and/or an at least substantially conformal insulating (dielectric) coating, more typically a comparatively thin insulating layer, in particular an insulating layer with a layer thickness in a range from about 0.4 mm to about 2.0 mm.

In a block 1300, a fiber-reinforced plastic filling is formed at and on the insulating material.

In a block 1400, the fiber-reinforced plastic filling is covered with an electrically conductive material in electrical connection with the non-damaged portion. Typically, the fiber-reinforced plastic filling is completely covered with the electrically conductive material.

FIG. 2C illustrates a flow chart of a method 1001 for repairing a spar cap of a wind turbine rotor blade. Method 1001 is typically similar to method 1000 explained above with respect to FIG. 2B but more specific.

In a first block 1051, a damage of a spar cap of a wind turbine rotor blade is detected and exposed.

In a subsequent block 1101, a damaged portion of the spar cap is removed as explained above for block 1100 of FIG. 2B.

In a subsequent block 1210, electrically non-conductive fibers such as glass fibers may be laid up on the bottom wall and sidewalls of the recess formed in block 1101. This may e.g. be achieved by hand layup of the electrically non-conductive fibers.

In a subsequent block 1220, the electrically non-conductive fibers are impregnated with a resin. For this purpose, a vacuum infusion of the resin may be used.

In a subsequent block 1230, the resin impregnated electrically non-conductive fibers may be cured, e.g. thermally.

In a subsequent block 1310, electrically conductive fibers such as carbon fibers may be laid up on the impregnated (and typically cured) electrically non-conductive fibers. This may e.g. be achieved by hand layup of the electrically conductive fibers.

In a subsequent block 1320, the electrically conductive fibers are impregnated with a resin. For this purpose, a (further) vacuum infusion of the resin may be used.

In a subsequent block 1330, the resin impregnated electrically conductive fibers may be cured, e.g. thermally.

As indicated by the dashed arrow in FIG. 2C, curing the impregnated electrically non-conductive fibers and curing the impregnated fibers (forming the repair patch) may be achieved in a common curing process 1330.

In a subsequent block 1350, one or more edge regions of the cured impregnated fibers and the repair patch formed in the recess may be mechanically smoothed.

In a subsequent block 1410, electrically conductive fibers such as carbon fibers are laid up on the so far cured impregnated fibers and the repair patch formed in the recess and optionally mechanically smoothed, respectively. This may also e.g. be achieved by hand layup of the electrically conductive fibers.

In a subsequent block 1420, the electrically conductive fibers are impregnated with a resin. For this purpose, a (further) vacuum infusion of the resin may be used.

In a subsequent block 1430, the resin impregnated electrically conductive fibers may be cured, e.g. thermally, to finally form the electrically conductive material and the electrical bypass, respectively, in electrical connection with the non-damaged portion.

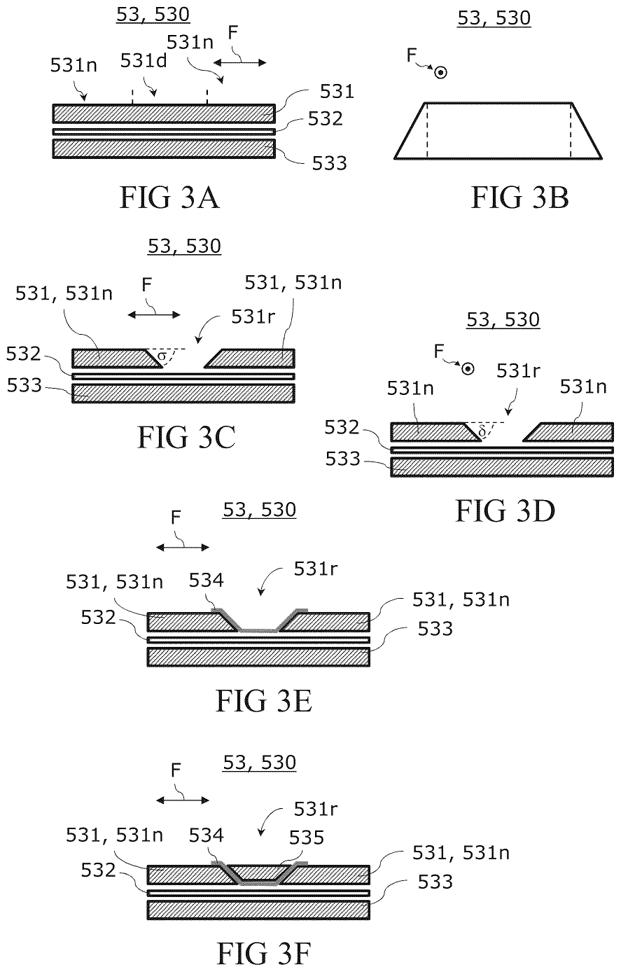

With regard to FIG. 3A to FIG. 4D a flow chart of a method of repairing a damaged spar cap and the repaired spar cap, respectively, is explained. This method is typically similar to methods 1000, 1001 explained above with respect to FIG. 2B and FIG. 2C, but more specific in certain respects.

As illustrated in FIG. 3A showing a cross-sectional view through an exemplary spar cap 53, spar cap 53 may be implemented as a fiber-reinforced plastic part 530 formed by a stack of unidirectional fiber reinforced layers 531, 533 (as indicated by the main fiber direction F of the non-damaged portion 531n), in particular a stack of carbon fiber reinforced layers 531, 533, and an interposed electrically conductive interlayer 532 typically forming a main down-conductor during a lightning strike. Interlayer 532 is typically arranged between and at the fiber reinforced layers 531, 533. In other words, the respective distances between interlayer 532 and fiber reinforced layers 531, 533 may at least substantially be zero.

FIG. 3B shows another cross-section through spar cap 53, i.e. a cross-section which is perpendicular to the cross-section of FIG. 3A and main fiber direction F, respectively.

As indicated by the dashed lines in FIG. 3B, spar cap 53 may have a central part which is formed by the layers 531-533 and interposed between two lateral wedge elements.

In the exemplary embodiment, spar cap 53 is damaged in a damaged portion 531d of upper fiber reinforced layer 531.

As illustrated in FIG. 3C and FIG. 3D showing respective cross-sections after removing damaged portion 531d, a recess 531r may be formed in layer 531.

Damaged portion 531d is typically removed mechanically.

In particular, damaged portion 531d may be removed by chamfering layer 531 with respect to the main fiber direction F direction F as well as with respect to a second direction perpendicular to the main fiber direction F.

The angles σ, δ between the sidewalls of the recess 531r and the bottom wall of the recess (and the upper and lower surface of fiber reinforced layer 531, respectively) may be substantially at least equal. Typically, at least one of the angles σ, δ, more typically both angles σ, δ is/are in a range from about 0.4° to 12°, more typically in a range from about 0.6° to 6°.

The damaged portion is typically completely removed.

For safety reasons, even adjoining parts of the non-damaged portion 531n may be removed and/or the electrically conductive interlayer 532 exposed.

Thereafter, an (electrically) insulating layer 534 covering the bottom and side walls of the recess 531r may be formed, typically at least at and/or on the bottom and side walls of recess 531r. The resulting structure is shown in FIG. 3E.

Thereafter and as illustrated in FIG. 3F, a patch 535, in particular a pre-impregnated fiber patch, may be inserted into the recess 531r to substantially or completely fill the recess. Optionally, an adhesive may be applied on the insulating material 534 prior to inserting patch 535. As show in FIG. 4A, patch 535 may be shaped in accordance with the geometry of the remaining recess above insulating layer 534.

Alternatively and as illustrated in FIG. 4B, the remaining recess above insulating layer 534 may be filled by layup of the fibers, for example carbon fibers, and subsequent impregnating the fibers with a resin for forming a similar patch 535′.

Thereafter, the respective patch 535, 535′ may be cured, e.g. thermally.

In particular in embodiments referring to forming the patch 535′ using layup of the fibers, edge regions 535e of the cured impregnated fibers (patch 535′) may be mechanical smoothed, in particular by chamfering and/or grinding.

Thereafter and as illustrated in FIG. 4C showing a cross-sectional view and FIG. 4D showing a top view of a resulting repaired spar cap 53, the fiber-reinforced plastic filling/cured patch 535, 535′ as well as any parts of the insulating layer 534 arranged on the non-damaged portion 531n and between the non-damaged portion 531n and the fiber-reinforced plastic filling/cured patch 535, 535′ may be covered with an electrically conductive material 536 in electrical connection with the non-damaged portion 531n to form an electrical bypass.

Electrical bypass 536 may be implemented as a carbon mesh, a carbon tow, a metal mesh, or a (unidirectional) fiber-reinforced plastic layer having electrically conductive fibers, in particular a carbon fiber-reinforced plastic layer.

Exemplary embodiments of repaired spar caps and methods for repairing spa caps are described above in detail. The spar caps and methods are not limited to the specific embodiments described herein, but rather, components of the spar caps and/or steps of the methods may be utilized independently and separately from other components and/or steps described herein.

Although specific features of various embodiments of the invention may be shown in some drawings and not in others, this is for convenience only. In accordance with the principles of the invention, any feature of a drawing may be referenced and/or claimed in combination with any feature of any other drawing.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

This written description uses examples to disclose the invention, including the best mode, and also to enable any person skilled in the art to practice the invention, including making and using any devices or systems and performing any incorporated methods. While various specific embodiments have been disclosed in the foregoing, those skilled in the art will recognize that the spirit and scope of the claims allows for equally effective modifications. Especially, mutually non-exclusive features of the embodiments described above may be combined with each other. The patentable scope of the invention is defined by the claims, and may include other examples that occur to those skilled in the art. For example, the control system of the wind farm may be provided by one centralized controller or a plurality of interconnected controllers. Such other examples are intended to be within the scope of the claims if they have structural elements that do not differ from the literal language of the claims, or if they include equivalent structural elements with insubstantial differences from the literal language of the claims.

REFERENCE NUMBERS

| | |
|---|---|
| rotor blade | 10′, 108 |
| rotor blade shell | 11 |
| leading edge of rotor blade | 12 |
| trailing edge of rotor blade | 13 |
| chord line | 15 |
| rotor axis | 30 |
| spar | 50 |
| spar cap | 51, 52, 53 |
| spar web | 55 |
| wind turbine | 100 |
| nacelle | 102 |
| tower | 104 |
| yaw system | 105 |
| rotor | 106 |
| meteorological mast | 107 |
| pitch system | 109 |
| hub | 110 |
| stacked layer of spar cap | 530 |
| fiber-reinforced plastic part/plank | 531, 533 |
| damaged/defect portion | 531d |
| recess | 531r |
| optional internal conductive layer | 532 |
| insulating material/layer | 534 |
| fiber-reinforced plastic filling/repair patch | 535, 535′ |
| electrically conducting material/layer/bypass | 536 |
| method, method steps | 1000-1450 |
| F | first direction/ |
| | (main) fiber direction |

1-15: (canceled)

16. A method for repairing a spar cap of a wind turbine blade, the spar cap having a fiber-reinforced plastic part, the method comprising:
removing a damaged portion of the fiber-reinforced plastic part thereby forming a recess adjacent to a non-damaged portion of the fiber-reinforced plastic part, the non-damaged portion including electrically conductive fibers substantially orientated in a first direction;
covering a bottom wall and a sidewall of the recess with an insulating material;
forming a fiber-reinforced plastic filling on the insulating material; and
covering the fiber-reinforced plastic filling with an electrically conductive material in electrical connection with the non-damaged portion.

17. The method of claim 16, wherein the recess is formed at an outer surface of the fiber-reinforced plastic part, and wherein the damaged portion is removed by chamfering the fiber-reinforced plastic part.

18. The method of claim 17, wherein the fiber-reinforced plastic part is chamfered such that the recess is, in a top view, surrounded by the non-damaged portion.

19. The method of claim 16, wherein the insulating material is placed to extend onto the non-damaged portion next to the sidewall of the recess.

20. The method of claim 16, wherein the insulating material includes electrically non-conductive fibers and wherein the covering the bottom wall and the sidewall of the recess with the insulating material comprises:
forming at least on insulating fiber-reinforced layer on the bottom wall and the sidewall of the recess;
layup of the electrically non-conductive fibers;
impregnating the electrically non-conductive fibers with a resin; and
curing the impregnated electrically non-conductive fibers.

21. The method of claim 16, wherein the forming the fiber-reinforced plastic filling comprises substantially filling a remaining recess above the insulating material with electrically conductive fibers by one of:
applying an adhesive on the insulating material and filling a remaining recess above the adhesive with a pre-impregnated patch having electrically conductive fibers, and curing the patch;
layup of the electrically conductive fibers, impregnating the electrically conductive fibers with a resin, and curing the impregnated electrically conductive fibers;
the method further comprising mechanically smoothing an edge region of the cured impregnated electrically conductive fibers prior to covering the fiber-reinforced plastic filling with the electrically conductive material.

22. The method of claim 21, wherein the curing the patch or the impregnated electrically conductive fibers comprises a common curing process.

23. The method of claim 16, wherein the covering the fiber-reinforced plastic filling with the electrically conductive material comprises at least one of:
forming the electrically conductive material to extend from the fiber-reinforced plastic filling onto the non-damaged portion of the fiber-reinforced plastic part;
completely covering the fiber-reinforced plastic filling and the insulating material;
layup of electrically conductive fibers in the electrically conductive material, impregnating the electrically conductive fibers with a resin, and curing the impregnated electrically conductive fibers.

24. The method of claim 16, wherein the electrically conductive material is formed by or includes at least one of: carbon fibers, a carbon mesh, a carbon tow, a metal mesh, or a fiber-reinforced plastic layer.

25. The method of claim 16, wherein the electrically conductive material includes electrically conductive carbon fibers.

26. The method of claim 16, wherein the fiber-reinforced plastic part includes a stack of fiber reinforced layers.

27. The method of claim 26, wherein the fiber-reinforced plastic part includes an electrically conductive interlayer arranged between two of the fiber reinforced layers.

28. The method of claim 27, wherein the electrically conductive interlayer includes a glass-fiber or a carbon-fiber hybrid layer.

29. A rotor blade, comprising:
a spar cap, the spar cap comprising a fiber reinforced plastic part, wherein the fiber reinforced plastic part comprises an electrically conductive fiber reinforced layer with a repair made therein in accordance with the method of claim 16, wherein the repair comprises:
a fiber-reinforced repair patch inserted into the recess made in the electrically conductive fiber reinforced layer;
the insulating material in the recess covering a bottom and a sidewall of the fiber-reinforced repair patch; and
the electrically conductive material arranged on and in electrical connection with the electrically conductive fiber reinforced layer and covering a top side of the fiber-reinforced repair patch.

30. The rotor blade of claim 29, wherein the electrically conductive fiber reinforced layer and the fiber-reinforced repair patch comprise fibers orientated in a first direction, the electrically conductive fiber reinforced layer comprising electrically conductive fibers, the insulating material comprising glass fibers and electrically conductive fibers, and the electrically conductive material comprising at least one of: electrically conductive fibers, a carbon mesh, a carbon tow, a metal mesh, or a fiber-reinforced plastic layer.
